(19) United States
(12) Patent Application Publication
(10) Pub. No.: US 2007/0124970 A1
(43) Pub. Date: Jun. 7, 2007

(54) Transversely-illuminated display

(76) Inventor: Thor Daniel Hjaltason, Arlington, TX (US)

Correspondence Address: CARR LLP, 670 FOUNDERS SQUARE, 900 JACKSON STREET, DALLAS, TX, 75202, US

(21) Appl. No.: 11/295,238

(22) Filed: Dec. 6, 2005

(51) Int. Cl. G09F 13/18

(52) U.S. Cl. 40/546

(57) ABSTRACT

A transversely-illuminated display including a transparent sheet with a front face and a rear face wherein the light-transparent sheet includes a light source disposed in a recess in the sheet. The display further includes a front image layer disposed on a front face of the transparent sheet and a rear image layer is disposed on a rear face of the transparent sheet substantially in registry with the front image layer, wherein the front image layer and the rear image layer are positioned so that the light within the transparent sheet will shine onto the rear image layer thereby to enhance illumination of the rear image layer. The display has a structure such that a portion of the light within the transparent sheet forms an image of a halo or aura of light surrounding the rear image layer.

### FIELD OF THE INVENTION

The present invention relates to illuminated signs and displays.

### DESCRIPTION OF THE RELATED ART

Edge-illuminated signs are known. In one example of an edge-illuminated sign, a transparent plastic sheet is illuminated by a light source disposed along an edge thereof so that light passes through the sheet material in a direction along the plane of the sheet. An image to be displayed is formed on one of the faces of the sheet whereby the light contrast between the image and the remainder of the sheet increases the visual impact of the image to a person viewing the sign. A typical known edge-illuminated prior art sign as illustrated in FIG. 1.

Referring to FIG. 1, a transparent plastic sheet 2, typically of acrylic plastic material, which is rectangular in shape has one upper edge 4 thereof received in a lamp housing 6 in which an elongate bulb 7, typically a fluorescent bulb, and electrical fittings 9 therefor are received, the bulb extending substantially along the length of the edge 4. In use, an end cap 8 is fitted over each end 10 of the lamp housing 6. In FIG. 1, which is a partially exploded view, one end cap 8 is shown in its removed configuration and the bulb 7 and electrical fittings 9 are partially removed so that the edge 4 of the sheet 2 is readily visible. The sheet 2 is provided either on its frontmost face 12 or its rearmost face 14, the direction being with respect to the intended position of a view of the sign, with an image 16. The image 16 may be formed by engraving the surface of the sheet 2 or by printing a partially transparent printed ink layer on the surface of the sheet 2, for example by screen printing. When the bulb 7 is illuminated, light emitted from the bulb 7 passes along the sheet 2 from the edge 4 and is internally reflected at the sheet/air interfaces. When the image 16 is engraved, light passing along the sheet 2 is reflected and refracted at the engraved edges thereby illuminating the edge of the image 16. When the image 16 is printed, the internally reflected light is incident on the rear surface of the image 16 and is partially transmitted to the front surface of the image 16 thereby to provide an illuminated image.

When the image is engraved this increases the cost and complexity of manufacture of the illuminated sign. When the image is printed, the degree of contrast of the image is not particularly high and so the sign is not particularly effective in ambient conditions of high light intensity. Furthermore, for both prior arrangements the nature of the images which can be conveyed by the signs is relatively limited.

U.S. Pat. No. 5,009,019 and WO-A-93/07605 are both in the name of the present inventor and relate to sign plates for illuminated signs. Both of these prior specifications disclose a sign plate for an illuminated sign which is intended to be illuminated by a light source disposed behind a rearmost face of the sign plate.

An improvement in the art of edge-illuminated signs is represented by U.S. Pat. No. 6,240,664, issued Jun. 5, 2001, to the present inventor. This prior development, depicted in FIGS. 2 and 3, improves edge-illuminated signs by providing a transparent sheet 32 with a front face 40, a rear face 42 and a transparent edge or plane 129 that connects the front face 40 to the rear face 42, wherein the transparent edge 129 is positioned to receive light from a fluorescent light bulb 122 in a housing 126 through a slot 128 in the housing 126 transmission transversely through the transparent sheet 32. The sign 120 further includes the front image layer 44 disposed on a front face 40 of the transparent sheet 32, wherein the front image layer 44 has a reflective surface 58 adjacent the front face 40. A rear image layer 46 is disposed on the rear face 42 of the transparent sheet 32 substantially in registry with the front image layer 44, wherein the front image layer 44 and the rear image layer 46 are positioned so that the light within the transparent sheet 32 is reflected from the reflective surface 58 of the front image layer 44 onto the front side 56 of the rear image layer 46 thereby to enhance illumination of the rear image layer 46. An opaque and reflective layer 62 is also included. The sign has a structure such that a portion of the light within the transparent sheet 32 forms an image of a halo or aura of light surrounding the rear image layer.

Despite the improvement represented by U.S. Pat. No. 6,240,664, edge-illuminated signs still suffer shortcomings. In particular, the placement of the light source in a housing at an edge of the transparent sheet limits the size and/or shape of the sign, because the light intensity tends to degrade as it travels distances through the transparent sheet. Furthermore, the configuration of the sign is limited because the fluorescent, neon or incandescent light disclosed presents significant limits on placement opportunities for the light source. Because of the light dispersion and physical nature of the light sources such as fluorescent lamps, Neon, incandescent or other light sources used to edge-illuminate, they must be concealed in a proper housing attached to the edge of the substrate for maximum effect and safety, thus further limiting the construction and placement opportunities.

Accordingly, it is an object of the present invention to overcome the foregoing shortcomings of the prior art.

It is a further aim of the present invention to provide a transversely-illuminated display which can be manufactured cost-effectively and can provide enhanced illumination of the image as compared to known edge-illuminated signs.

It is a further aim of the present invention to provide a transversely-illuminated display which enables a wide variety of images to be displayed.

### SUMMARY OF THE INVENTION

Accordingly, the present invention provides a transversely-illuminated display including a visible light transparent curvilinear sheet with a front face and a rear face wherein the light-transparent curvilinear surface is positioned to receive light from a light source that is disposed in a recess in the transparent sheet and generally concealed from a viewer in a normal viewing position with respect to the display, for transmission edgewise along the transparent curvilinear plane of the transparent sheet. The display further includes a front image layer disposed on a front face of the transparent sheet, wherein the front image layer has a reflective surface. A rear image layer is disposed on a rear face of the transparent sheet substantially in registry with the front image layer and having a similar shape, wherein the front image layer and the rear image layer are positioned so that the light within the transparent sheet is reflected onto the rear image layer thereby to enhance illumination of the rear image layer.

By “curvilinear sheet,” as used herein, is meant that the transparent sheet can be flat or curved about one or more axis (such as, for example a bowl or saddle shape), but that the front and back faces are generally parallel to each other. The plane of the transparent sheet also has some thickness, which is necessary for transmitting light transversely (i.e., edgewise) through the sheet.

The present invention further provides a transversely-illuminated display, the display comprising a transparent sheet including one or more recesses for receiving from at least one transversely-emitting light emitting diode that is generally concealed from a viewer along a normal sight-line to the display, for transverse edgewise transmission along the transparent sheet, a front image layer having a shape which is disposed on a front face of the transparent sheet and a rear image layer having a shape similar to the shape of the front image layer, and which is disposed on a rear face of the transparent sheet substantially in registry with the front image layer whereby, in use, light is reflected from the reflective surface onto the rear image layer thereby to enhance the illumination of the rear image layer.

### BRIEF DESCRIPTION OF THE DRAWINGS

Embodiments of the present invention will now be described by way of example only, with reference to the accompanying drawings, in which:

FIG. 1 is a partially exploded perspective view of a prior art edge-illuminated display;

FIG. 2 is a perspective view of another edge-illuminated display in accordance with the prior art;

FIG. 3 is a cross-section on line 3-3 of the edge-illuminated display illustrated in FIG. 2;

FIG. 4 is a perspective view of a transversely-illuminated display in accordance with a first embodiment of the present invention;

FIG. 5 is a cross-section on line 5-5 of the transversely-illuminated display illustrated in FIG. 4;

FIGS. 6 & 7 are schematic views similar to that of FIG. 5 illustrating the mechanism of the transmission of light along and out of the transparent plastic sheet of the display illustrated in FIG. 5;

FIG. 8 is a schematic views similar to that of FIG. 10, illustrating the mechanism of the transmission of light along and out of the transparent plastic sheet of another embodiment of the invention as illustrated in FIGS. 9-11;

FIG. 9 is a perspective view of a transversely-illuminated display in accordance with a second embodiment of the present invention;

FIG. 10 is a cross-section through a transversely-illuminated display in accordance with a second embodiment of the present invention;

FIG. 11 is an enlargement of the detail A in FIG. 9 showing an axially emitting LED in a recess in the edge of the sheet;

FIG. 12 is an enlargement of the detail B in FIG. 9 showing a transversely emitting LED in a recess through the plane of the sheet;

FIG. 13 is an enlargement of a transversely emitting LED in a recess partially through the plane of the sheet;

FIG. 14 is a frontal view of the display of the present invention from a normal viewing angle, showing examples of placement locations for the light sources;

FIG. 15 is an edge view of an embodiment of the display of the present invention having a curved sheet; and

FIG. 16 is a frontal view of an embodiment of the display of the present invention having a flat sheet with polycurved edges;

FIG. 17 is a perspective view of a transversely-illuminated display in accordance with another embodiment of the present invention;

FIG. 18 is an edge view of an embodiment of the display of the present invention depicted in FIG. 17;

FIG. 19 is an edge view of another embodiment of the display of the present invention; and

FIG. 20 depicts a side cross-section of an embodiment of a U-shaped border for use in the invention.

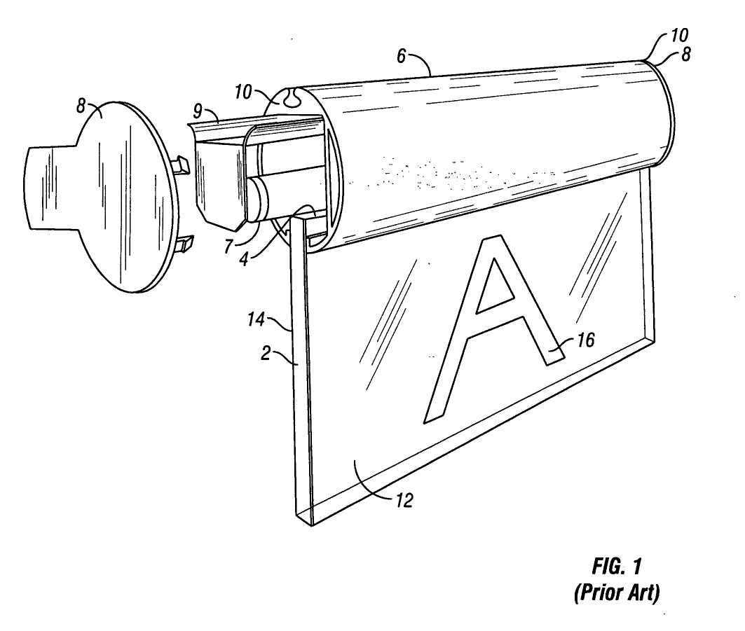

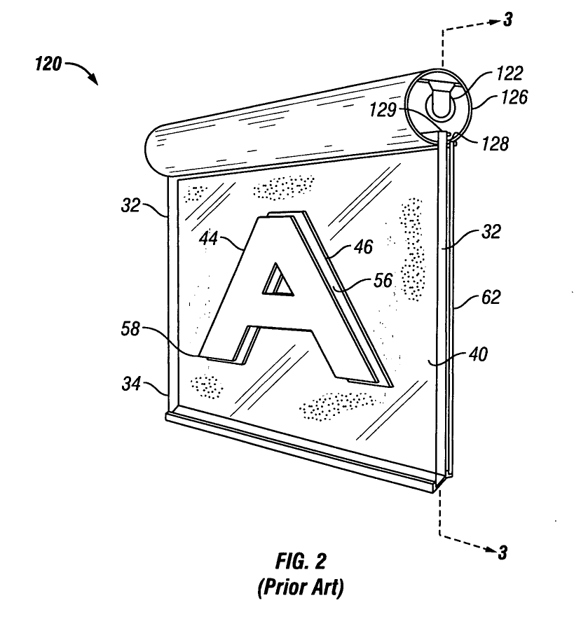

### DESCRIPTION OF THE PREFERRED EMBODIMENTS

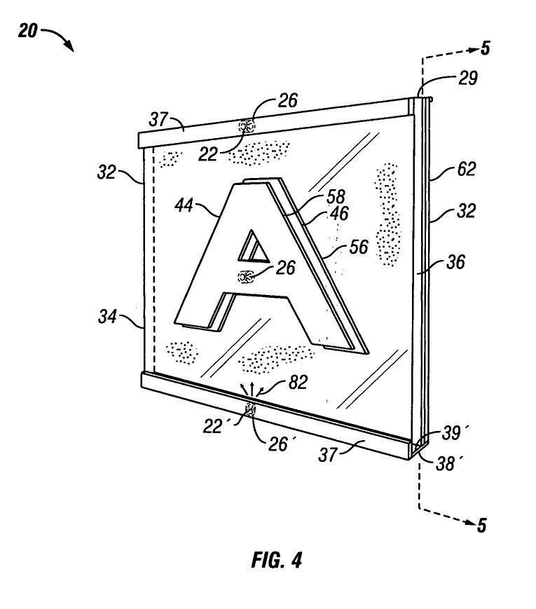

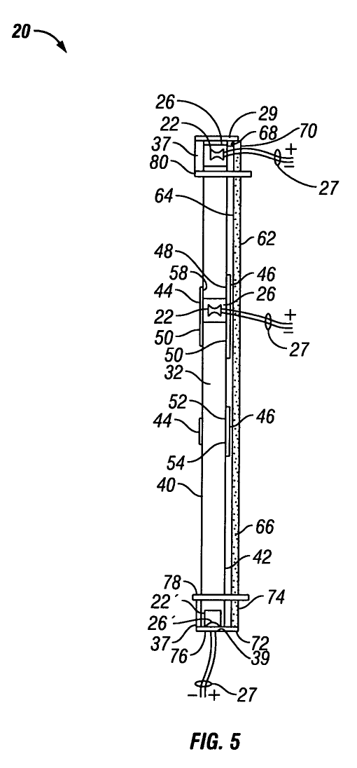

Referring to FIGS. 4 and 5, there is shown a transversely-illuminated display, designated generally as 20, in accordance with a first embodiment of the present invention. In the illustrated embodiment, the transparent curvilinear plastic or glass sheet 32 is flat and rectangular in shape, having two upright side edges 34, 36 and a lowermost edge 38, in addition to upper edge 29. Although a rectangular transparent sheet 32 is depicted, the transparent sheet 32 can be any shape, including round, oval, polycurved or polygonal. Transparent sheet 32 can be made from generally rigid material (such as glass) or generally flexible material, such as polycarbonate.

The display 20 comprises one or more light sources 22, that can be but need not be in the form of an LED, mounted in a recess 26 formed at or near the upper edge 29 of the transparent sheet 32, behind an opaque border 37. The display 20 can also include another light source 22, which can be an LED, mounted in a recess 26 formed behind an opaque front image layer 44. The light source or sources 22 each have electrical leads 27 which extend from the light source 22. The light source 22 is disposed in recess 26 in the transparent plastic sheet 32. Recess 26 is conveniently a hole or pocket drilled, milled, molded or otherwise formed in transparent sheet 32. Transparent sheet can be made in a wide range of thickness, from a few tenths of millimeters to several millimeters. However, the thickness of sheet 32 is generally small in relation to the length of sheet 32.

Another light source 22′, which can be an LED, can be mounted in a recess 26′ formed at or near the lower edge 38 of a transparent sheet 32. If desired, a light transmitting glue or resin, such as silicon or polyurethane, can be interposed into any or all of the recesses 26 or 26′ between light sources 22 and 22′, respectively. Either or both of edges 29 or 38 can be perpendicular or slanted to the plane of the sheet 32. Whether perpendicular or slanted, edges 29 or 38 can have a mirror-like reflective face 39 or can be colored white or any desired color. Similar slanted or perpendicular edges can also be disposed on the sides 34 and 36 of the sheet 32.

As is shown clearly in FIG. 5, the lowermost edge 38 can be, but need not be, inclined to the plane of the sheet 32 with the reflective internal face 39 of the edge 38 facing towards the front face 40 and away from the rear face 42 of sheet 32. The inclined edge 38 is preferably at an angle of less than about 45 degrees to a line perpendicular to the sheet 32 so that light is reflected back from the edge 38 into the sheet 32 at a relatively low angle so as to subsequently be internally reflected back up through the sheet 32 with minimal loss of light intensity. In an alternative arrangement, the inclined edge 38 faces towards the rear face 42 rather than the front face 40.

The front face 40 of the sheet 32 has disposed thereon a front image layer 44 which is patterned in the shape of an image to be displayed by the display 20 (in the illustrated embodiment, the letter A which is shown merely by way of example). The rear face 42 of the sheet 32 has disposed thereon a correspondingly shaped rear image layer 46 which is disposed in registry with the front image layer 44. In the illustrated embodiment, the width of the rear image layer 46 (in the plane of the layer 46) is dimensionally larger than that of the front image layer 44 whereby the rear image layer 46 defines, in regions such as regions 48, 50, 52, 54 illustrated in FIG. 5, a peripheral margin surrounding and highlighting the image conveyed by the front image layer 44. The front image layer 44 has a rearwardly directed surface 58 which can be specularly or diffusively reflective and can also be any color. The front image layer 44 can comprise a self-adhesive plastic (e.g. vinyl) film which has an underlying self-adhesive reflective surface 58 or can be screen printed, printed or painted. The front image layer 44 may be fluorescent or translucent and of any desired color. The surface of front image layer 44 adjacent to the sheet 32 may have a metallic and/or brightly colored (e.g. white or other color) paint layer and/or a metallized or brightly colored coating. The inner surface 58 of front image layer 44 may include reflective, fluorescent or any other desired colors and can also be least partially translucent. The front surface 51 of such a front image layer 44 may be provided with any suitable color, pattern or image, either by such a color, pattern or image being present in the layer or having been applied thereto. The front image layer 44 may comprise a layer of any desired color or colors and can be applied by a printing technique, such as screen printing or inkjet printing.

The front face areas 48, 50, 52 and 54 of rear image layer 46 that forms the peripheral margin can comprise a layer of fluorescent or any color material or combination of colors can have been printed, for example by screen printing, or otherwise applied onto the rear face 42 of the sheet 32. The rear image layer 46 can be opaque or translucent for visible light. In an alternative embodiment, the rear image layer 46 may comprise a self-adhesive plastic (e.g. vinyl) film which can be reflective, fluorescent and/or translucent and can be any color, whether or not fluorescent. The front and rear image layers may, but need not, incorporate phosphorescent materials.

A backing sheet 62 can be mounted behind and parallel with the sheet 32. The backing sheet 62 has a front face 64 which can be either spaced slightly from the rear face 42 of the sheet 32 by air or by a clear or transparent sheet or in direct contact with it, but is preferably not adhered to parts of the rear face 42 of sheet 32 that are not covered by rear image layer 46. The backing sheet 62 preferably comprises a substantially opaque plastic sheet having a desired color and/or a fluorescent coating, and which can be reflective (specularly or diffusely). The backing sheet 62 may have any desired image or pattern on the front face 64 or the rear face 66 thereof when the backing sheet 62 is translucent. Alternatively, the backing sheet 62 may comprise an opaque sheet or a transparent plastic sheet having a substantially opaque coating on the front face 64.

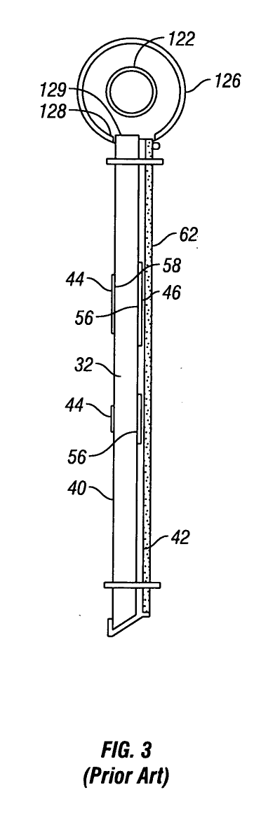

There can be a mount 68 for the upper edge 70 of the backing sheet 62. A bottom mount 72 is provided along the respective adjacent bottom edges 38 of the transparent sheet 32 and the backing sheet 62. Preferably, but not necessarily, the inner surface 76 of the bottom mount 72 which abuts the inclined bottom edge 38 of the transparent sheet 32 is reflective, either specularly or diffusely. As shown schematically in FIG. 3, clamping devices 78, 80 may be provided for holding together the assembly of the transparent sheet 32 and the backing sheet 62.

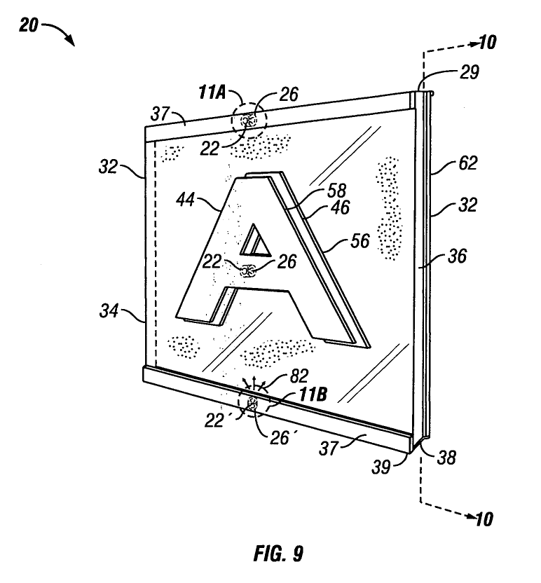

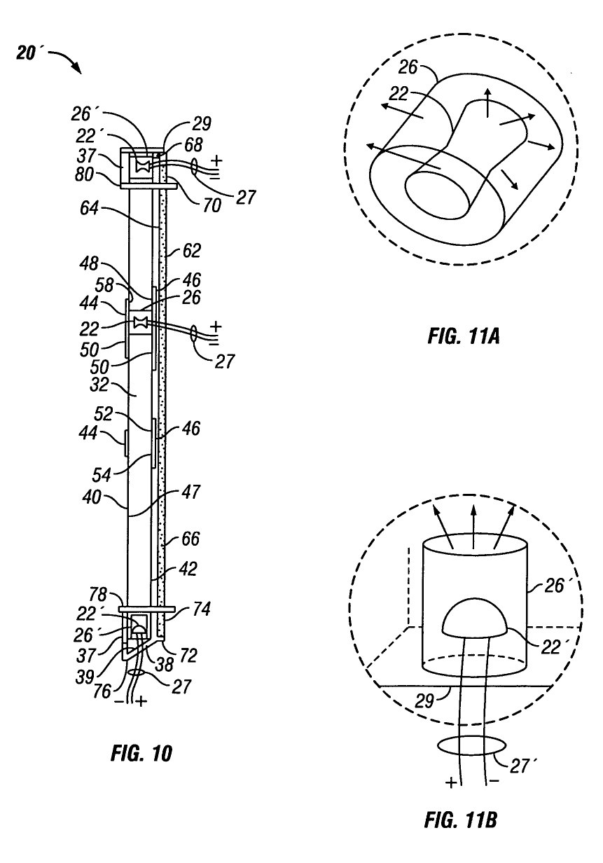

As can be seen in FIGS. 4-11, the light sources 22 (22′) can be positioned in recesses 26 (26′) in the transparent sheet 32, generally concealed from direct view by viewer at most normal positions behind an opaque obstruction, such as border 37 or generally opaque portion of front image layer 44. Depending upon the type of display, and the aesthetics desired, a light source can be placed at one position within a recess in the sheet 32 on or near an edge of the transparent sheet 32, behind the border 37, at multiple places on or near the edges 29, 34, 36 or 38, or at one or more places concealed behind an opaque portion of front image layer 44.

The light source 22 is preferably an LED light. Because LED's have a high efficiency as compared to incandescent light sources and are small in comparison to the amount of light produced, positioning the LED's directly in recesses 26 (26′) in the transparent sheet 32 should not cause unacceptable temperature levels in the transparent sheet 32. Although an LED is preferred, another type of light source 22 (22′) can be used provided that the light source 22 (22′) is sufficiently small to fit in the recesses 26 or 26′ and to remain concealed and not overheat the transparent sheet 32 in the vicinity of the recess 26 or 26′ where it is placed. The LED or other light source 22 or 22′ can emit white or any desired color or colors of light.

Advantageously, the light sources 22 (22′, 22″) have a strong emittance in a generally transverse direction out from the light source 22 (i.e., perpendicular to the plane of the transparent sheet) and a small emittance in the axial direction. This will tend to increase the efficiency of the utilization of the light, by directing a large amount of the emitted light along the plane of the transparent sheet 32. Of course, it is not required that light from the light sources 22 be transmitted precisely along the plane of the transparent sheet 32 and, in fact, some internal reflection from the front and back sides of the transparent sheet 32 is permissible and desirable in provide good illumination of the rear image layer 46 for providing a “beveled” or “neon-like” appearance.

A strong emittance in a generally transverse direction can be accomplished by using a light source 22 that has a reflective axial end but is free to emit transversely. A light source 22 configured in this manner can generally emit transversely up to 360 degrees around the axis of the light source 22, through the plane of the transparent sheet 32.

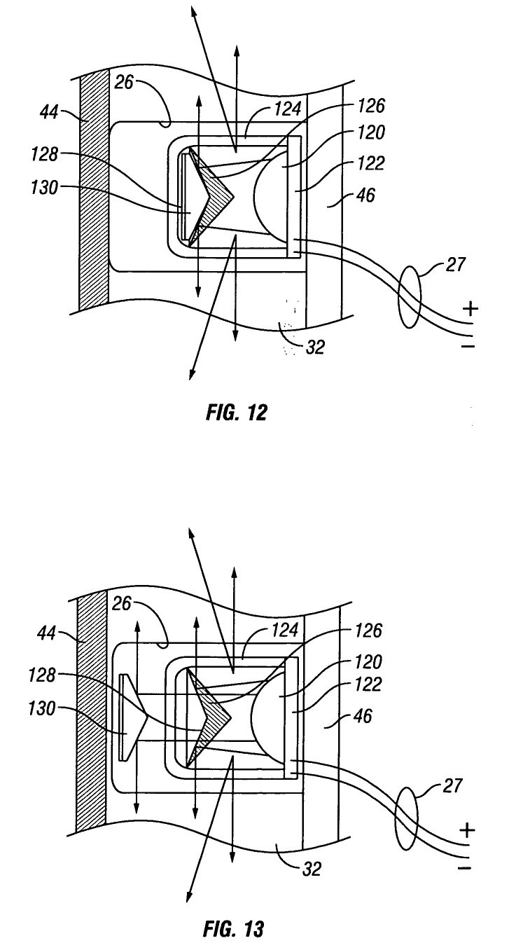

An example of a strongly transversely emitting LED construction is depicted in FIGS. 12 and 13. Light source 22 includes an LED element 120 mounted to a support 122 disposed within a transparent protective glass or plastic housing 124. A conical refractor 126 is disposed at the axial end of the housing 124, either inside, outside or forming part of the protective housing 124. The conical refractor 126 has a hollow cone region 128 in its end so that the refractor acts, to a large extent, like an internally reflecting prism, thus refracting and reflecting light that is axially incident on it from the LED transversely (i.e., edgewise into the transparent sheet 32), as indicated by the arrows. In addition to conical refractor 126, or as a substitute therefore, an axially disposed conical reflector 130 can be included at the end of the light source 22, within recess 26, to reflect any additional light that is axially incident on it from the LED transversely, as indicated by the arrows.

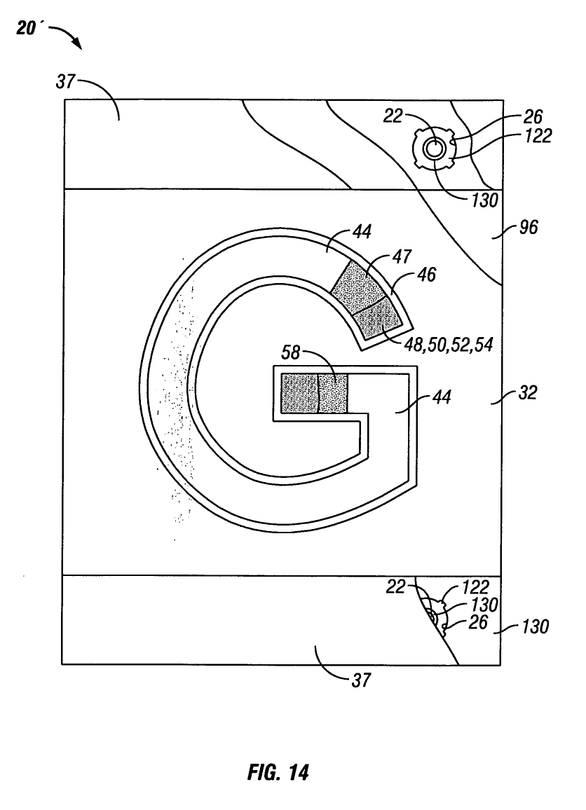

With reference now to FIG. 14, a frontal view of an embodiment of the invention including two LED light sources 22, including the support 122 and the conical reflector 130, mounted in recesses 26 within the transparent sheet 32, near the upper and lower edges of the sheet 32, behind respective generally opaque borders 37. The display depicts a letter “G,” including the front image layer 44′ and a rear image layer 46′, the inside surface 58′ of the front image layer, which can be reflective, the rear image layer 46′, its front face 47′, the transparent sheet 32′ and the backing sheet 96′.

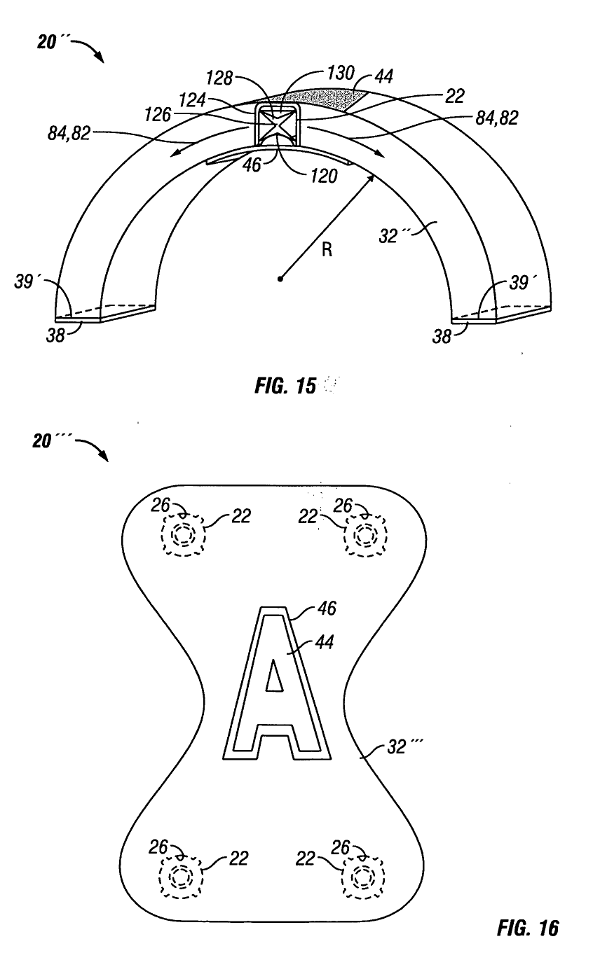

With reference now to FIG. 15, an embodiment of display 20″ wherein transparent sheet 32″ is curved with a radius “R” is depicted. In this embodiment, a light source 22, which can be a transversely emitting LED source, is disposed in a recess 26, concealed behind an opaque front image layer 44″ and in front of rear image layer 46″. Alternatively, the light source 22 could be disposed behind an opaque border 37″, with the front image layer and rear image layer being disposed elsewhere on the transparent sheet 32″. As can be seen, it is not necessary that the light source be disposed at or near the edge of the transparent sheet 32″. As depicted, transparent sheet 32″ can also be curved along more than one axis, so it has a “saddle” or other three dimensional shape.

With reference now to FIG. 16, an embodiment of display 20′″ wherein transparent sheet 32′″ is flat, but polycurved at its edges, is depicted. In this embodiment, light sources 22, which can be a transversely emitting LED source, are disposed in recess 26. The light sources 22 can be disposed behind an opaque border (not shown in FIG. 16) or behind a front image layer 44′″ and in front of a rear image layer 46′″. As can be seen, it is not necessary that the light sources be disposed at or near the edge of the transparent sheet 32′″.

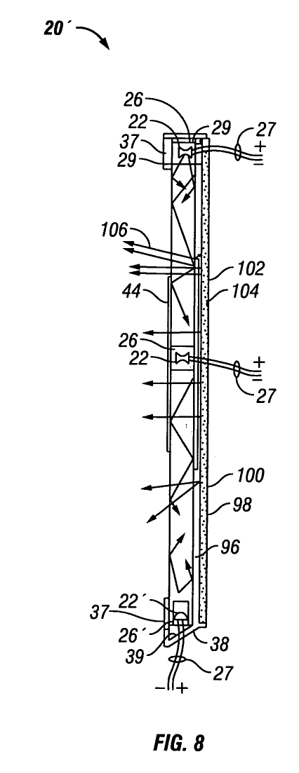

As depicted in FIGS. 8-11, a light source 22′ that emits more strongly in the axially direction of the light source 22′ can also be used in place or one or more of light sources 22. In this case, the light source 22′ is disposed in a recess 26′ oriented with have a strong emittance in the axial direction and be oriented with its axis generally along the plane of the transparent sheet 32. In this case, the light will initially travel generally in a smaller angle of emittance away from the light source 22′. This may be desirable in some designs, where a non-uniformity of the intensity of the light on portions of the display is desired. This could be desired, for example, in displays for aesthetic reasons, where different portions of the display are to be illuminated with different colors, where the display had a shape or configuration that favors this, or any other reason.

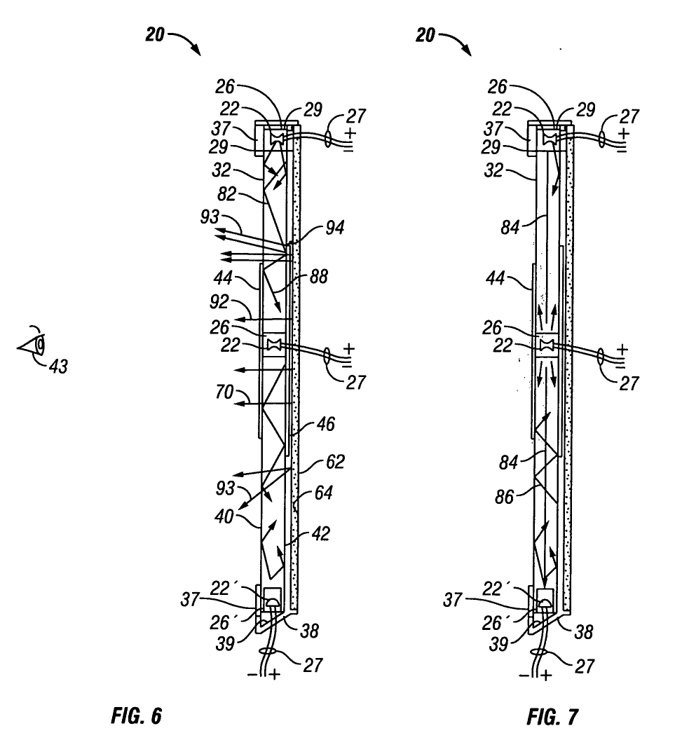

The operation of the transversely-illuminated display 20 will now be described with reference to FIGS. 6 and 7.

In use, the light source 22 is illuminated and as shown in FIG. 6, light beams, such as light beams 82, which are not perfectly parallel to the plane of the transparent sheet 32 are transmitted through the plane of the sheet 32 by internal reflection at alternatively the front and rear faces 40, 42 of the transparent sheet 32. It will be seen that since in the illustrated embodiment the only layers which are formed on the front and rear faces 40, 42 of the transparent sheet 32 are the front and rear image layers 44, 46, there is an enhanced degree of internal reflection of light being transmitted along the sheet 32, the light being internally reflected at the sheet/air interfaces. If additional layers were present tightly in contact with the sheet faces, then the degree of internal reflection would be reduced because light would be absorbed into these additional layers, thereby reducing correspondingly the level of illumination of the desired image. For this reason, the backing sheet 62 may be adjacent to, but should not be adhered or otherwise tightly connected, bonded or adhered to the transparent sheet 32 because this would reduce the total amount of light internally reflected in the transparent sheet 32.

As shown in FIGS. 6 and 7, if the face 39 of lower edge 38 is slanted, any light beam 84 which is parallel to the plane of the transparent sheet 32 is transmitted edgewise down the entire length of the sheet 32 and subsequently reflected by internal reflection at the inclined face 39 of lower edge 38, which can be but need not be slanted, or diffusely or specularly reflected by reflection at the reflecting face 76 of the lower mount 72, and the reflected beam 86 is transmitted back up the transparent sheet 32 and subsequently internally reflected at the inner and outer faces 40, 42 of the transparent sheet 32. In this way, light from the light source 22 is transmitted throughout the whole body of the transparent sheet 32.

Light beams which are not parallel to the plane of the transmitting sheet 32 are reflected to a significant extent at the inner surface 58 of the front image layer 44, if surface 58 is reflective. This reflected light (e.g., at arrow 88) is reflected to a significant extent back onto the rear image layer 46. Rear image layer can have a fluorescent, white or any non-fluorescent color coating or layer. This provides an enhanced illumination of the rear image layer 46 so that the edges 48, 50, 52 and 54 of the rear image layer 46 which are not directly covered by (i.e. are at least partially exposed by) the front image layer 44 appear very bright to a viewer of the display (e.g. at arrow 93). This brightness can be enhanced by the fluorescent effect of the rear image layer 46 which strongly emits light as a result of being illuminated by light from the light source 22. The overall illumination effect to a viewer of the display 20, at the normal viewing position indicated by the eyeball 43, is a strongly illuminated annular border or highlight surrounding the image defined by the front image layer 44. This provides an illuminated outline at least partially around indicia defined by the front image layer 44.

The front image layer 44 may be substantially opaque or partially transmitting. If the front image layer 44 is partially transmitting, then as shown in FIG. 6, some light (e.g. at arrow 92) is reflected from the rear face 42 of the sheet 32 forwardly through the front image layer 44 whereby the image defined by the front image layer 44 is partially illuminated.

The rear image layer 46 can be partially transmitting and accordingly light (e.g. at arrow 94) passes rearwardly through the rear image layer 46 and onto the backing sheet 62. Such light is reflected from the backing sheet 62 at its front face 64 (e.g. at arrow 94) and such reflected light is transmitted forwardly through the transparent sheet 32. Such reflected light from the backing sheet 62 provides an image of a halo or aura of light surrounding the image defined by light reflected from the fluorescent rear image layer 46. The halo of light is illustrated in FIG. 6 as light beams 93. The color of the halo of light can be but need not be the same as that of the rear image layer 46. The color may be varied by applying an additional colored layer to the back of the rear image layer 46 or to the front of the backing sheet 62 or by varying the color of the light sources 22. The lateral width of the halo may be varied by altering the spacing between the transparent sheet 32 and the backing sheet 62.

A further embodiment of an illuminated display 20′ in accordance with the present invention is illustrated in FIG. 8-11, which is similar to the embodiment illustrated in FIGS. 6-7 except that the backing sheet 62 is replaced by film 98 having a transparent backing sheet 96 with a reflecting coating 94 on its rear face 100. The reflecting coating 94 comprises a self-adhesive plastic film 102 having a reflective front surface 104. Alternatively, the reflecting coating 94 is a printed layer. In a similar manner to that illustrated in and described with reference to FIGS. 6 and 7, a halo effect is provided around the rear image layer 46 by light being reflected off the reflecting surface of the film 98 (e.g. at arrow 106). Since the reflecting film 102 is on the face 100 of the backing sheet 96, which is remote from the transparent sheet 32, there is no requirement for the backing sheet 96 to be spaced in order to provide a visible halo effect.

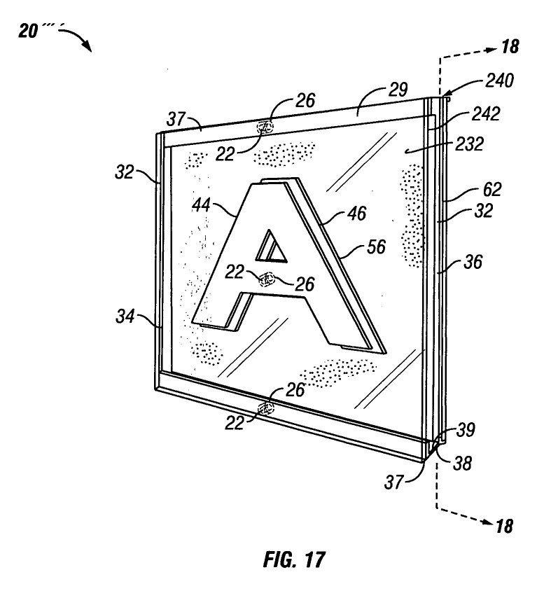

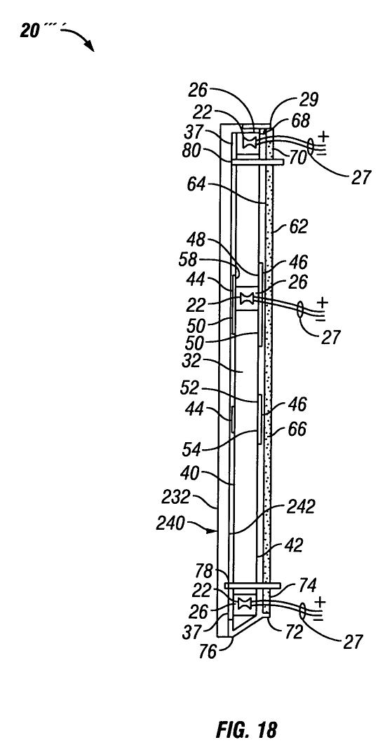

Referring now to FIGS. 17 and 18, there is shown a transversely-illuminated display, designated generally as 20″″, in accordance with another embodiment of the present invention. In the illustrated embodiment, the transparent plastic or glass sheet 32″″ is flat and rectangular in shape, has two upright side edges 34″″, 36″″ and a lowermost edge 38″″, in addition to upper edge 29″″. Although a rectangular transparent sheet 32″″ is depicted, the transparent sheet 32″″ can be any shape, including round, oval, polycurved or polygonal.

The display 20″″ comprises a light source 22, which can be in the form of an LED, mounted in a recess 26 formed at or near an edge 29 of a transparent sheet 32, behind an opaque border 37. The light source 22 has electrical leads 27 which extend from the light source 22. The light source 22 is disposed in recess 26 in the transparent plastic sheet 32. Recess 26 is conveniently a pocket or hole drilled, milled, molded or otherwise formed in transparent sheet 32. The display 20″″ can also include another LED light source 22 mounted in a recess 26 formed behind an opaque front image layer 44, and another LED light source 22′ axially mounted in an axial recess 26′ formed at or near the lower edge 38 of a transparent sheet 32. If desired, a light transmitting glue or resin, such as silicon or polyurethane, can be but need not be interposed into the recess 26 (26′, 26″) between the LED 22 (22′, 22″) and the recess 26 (26′, 26″). Edge 38 can also be perpendicular to the plane of the sheet 32. Whether perpendicular or slanted, edge 38 can have a mirror-like reflective face, or a diffusely reflective face, or can be colored white or any color. Similar slanted or perpendicular edges can also be disposed on the sides 34, 36 of the sheet 32.

In this embodiment, there is an additional transparent outer sheet 232 disposed on the outside of sheet 32. Transparent outer sheet 232 can be in contact with opaque border 37, can be spaced slightly away from it or can include the border as part of transparent outer sheet 232. In either case, the inside face 242 of outer sheet 232 can be slightly spaced away from the front face 40, even if it is only the thickness of the opaque border 37, or at least not bonded or adhered to it so as to prevent undesired light leakage.

In this embodiment, the rear face 242 of the outer sheet 232 (rather than the front face 40 of sheet 32, as depicted in FIGS. 4 and 5) is coated with a front image layer 44 which is patterned in the shape of an image to be displayed by the display 20 (in the illustrated embodiment, the letter A which is shown merely by way of example). As another alternative, the front face 42 of the outer sheet 32 can be coated with a front image layer 44.

As still another alternative construction, the front image layer can also be disposed on the front of outer sheet 232. In this alternative construction, the distance between the front image layer and the rear image layer is increased, thus giving greater “depth” to the peripheral margin surrounding and highlighting the image conveyed by the front image layer, without needing thicker material for the sheet 32.

By interposing a slight space between sheet 32 and outer sheet 232, internal reflection from the front face 40 of sheet 32, as well as internal reflection from both the front face 240 and reflection from the rear face 242 back toward sheet 32, which helps cause more light to strike the rear image layer 46 from where it is reflected back to the viewer. Also, in the case where the front image layer 44 is disposed on the inner face 242 of outer sheet 232, the outer sheet 232 can serve to protect image layer 44 from damage from accidental contact, vandalism or the elements.

The construction and operation of like-numbered elements of the embodiments of FIGS. 17 and 18 are otherwise the same as the embodiments of FIGS. 4-16 and need not be further described.

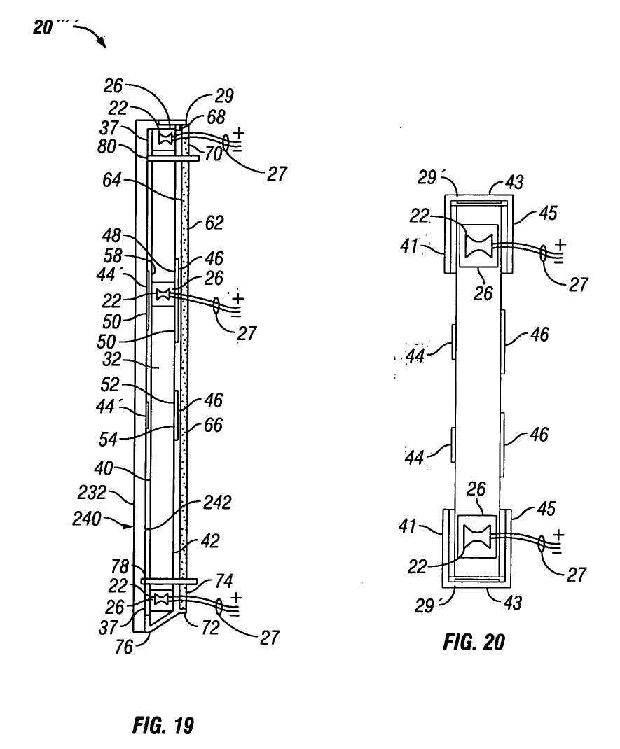

FIG. 20 shows a side cross-section of an embodiment of a U-shaped border 29′ for use in the invention. As depicted, the U-shaped border 29′ has an upper edge 41, a front edge 43 and a back edge 45. The U-shaped border 29′ can be disposed on the top and/or bottom edges of the sheets 32 of any of FIGS. 4-10 and 14-19, and can also be disposed on the side edges, if desired. The U-shaped border 29′ can accommodate any shape of the displays of FIGS. 4-10 and 14-19. In the case of a round display, for example, U-shaped border 29′ can go around the entire circumferential periphery of the sheet 32, and can have light sources 22 and/or 22′ in recesses 26 and/or 26′ of sheet 32 concealed by edges 41, 43 and/or 45.

It will be apparent to those skilled in the art that various modifications can be made to the illustrated embodiments within the scope of the invention. In the illustrated embodiments, the front image layer lies wholly within the lateral periphery of the rear image layer so that a peripheral highlight is defined by a border portion of the rear image layer which surrounds the front image layer. In alternative embodiments, although the rear image layer would generally be in registry with the front image layer, the rear image layer may be laterally offset relative to the front image layer or may have smaller dimensions than the front image layer on one side thereof so as to provide a highlight which is offset and does not extend all the way around the periphery of the front image layer. Thus the highlight may appear as a highlighted shadow on one side of the image defined by the front image layer. In a further embodiment, the front and rear image layers may be aligned and have the same size and shape. With this embodiment a highlight or outline can be seen by a viewer looking at the display at an angle.

In the embodiments of the invention, the front and rear image layers are separated by a distance corresponding to the thickness of the transparent sheet. When the front and rear image layers are illuminated in the manner described hereinabove, the viewer is able to detect a spacial difference between the front and rear image layers. This creates a three dimensional effect whereby the front and rear image layers appear to be connected by an inclined edge, giving the overall indicia a massive and solid appearance. The thickness of the three dimensional image corresponds to the thickness of the transparent sheet. The shape and angle of inclination of the inclined edge can be varied by altering the relative sizes and disposition of the front and rear image layers. For example, if the rear image layer is slightly larger in lateral dimension than the front image layer all around its periphery, then a relatively steep inclined edge will be apparent to a viewer of the display when the display is illuminated.

The images to be conveyed may comprise alphanumeric characters or other pictorial images. The front image layer may itself be printed or otherwise provided with images on its front surface.

In addition, although the illustrated embodiments utilise an LED light source, any other suitable light source may be employed, for example an electroluminescent lamp, an incandescent bulb, a neon bulb, a fluorescent bulb, blacklight, etc., providing that they are sufficiently small to remain concealed and have sufficiently small cooling requirements that they will not overheat the transparent sheet in the vicinity of where they are placed.

In alternative embodiments, a light reflective self-adhesive plastic layer, for example white or silver in color, is adhered over the edge of the sheet which is remote from the light source in order to reflect light back through the sheet. The mount along that edge may be square rather than inclined, particularly for small dimension displays.

In accordance with the invention, the provision of a fluorescent layer at least partially surrounding the front image layer on the transparent sheet, together with the provision of a reflecting surface on the rear of that front image layer, provides real technical advantage as opposed to transversely-illuminated displays in the prior art by forming an illuminated image having a relatively high intensity. This means that the transversely-illuminated display is clearly visible to a viewer even in relatively high intensity ambient light and when the display is intended to be seen from a substantial distance away.

The display of the present invention also has great flexibility in use by enabling a wide variety of visual effects to be reproduced. For example different colors can be displayed with or without fluorescent layers. An aura of one or more colors may wholly or partially surround the indicia. The color, size, shape and orientation of a highlight around the indicia may be selected as desired. Printed or patterned images defining or surrounding the indicia may be provided. The display can be manufactured very cost effectively by using known printing techniques and known techniques for applying patterned self-adhesive plastic films to rigid plastic sheets in the required positions.

The provision of a light reflection device at the edge of the sheet which is away from the light source ensures that the amount of light internally reflected in the sheet to cause illumination of the indicia is substantially maximised. This not only increases the visibility of the display but also provides even and uniform illumination of the indicia on both sides thereof, i.e. on the sides which are near to and remote from the light source.

What is claimed is:

1. A transversely-illuminated display comprising:
a first transparent sheet comprising a front face and a rear face, wherein light entering said first transparent sheet transversely will be generally transmitted edgewise through said sheet;
a light source disposed in a recess in the first transparent sheet for transmission edgewise through the first transparent sheet and positioned such that it is generally concealed from a viewer at a normal viewing position with respect to the display;
a rear image layer behind and facing said rear face of said first transparent sheet,
a front image layer substantially in registry with said rear image layer, disposed on a transparent sheet and in front of said rear image layer so that the outlines of said rear image layer are visible at normal viewing angles, said front image layer comprising an at least partially reflective surface facing toward said rear image layer;
wherein said front image layer and said rear image layer are positioned so that light received from said light source and transmitted through said first transparent sheet will shine onto said rear image layer thereby to enhance illumination of said rear image layer.

2. A display according to claim 1 wherein said front image layer comprises an adhesive plastic layer.

3. A display according to claim 1 wherein said front image layer comprises a printed layer.

4. A display according to claim 1 wherein said front image layer is partially light transparent.

5. A display according to claim 1 wherein said rear image layer comprises a fluorescent layer.

6. A display according to claim 5 wherein said fluorescent layer comprises an adhesive plastic layer.

7. A display according to claim 5 wherein said fluorescent layer comprises a printed layer.

8. A display according to claim 1 wherein said front image layer and said rear image layer are mutually shaped and oriented whereby said front image layer at least partially overlaps said rear image layer.

9. A display according to claim 8 wherein an annular peripheral portion of said rear image layer surrounding the front image layer is exposed by said front image layer.

10. A display according to claim 8 wherein said front image layer is laterally offset with respect to said rear image layer.

11. A display according to claim 1 wherein said front and rear image layers are dimensioned and positioned with respect to each other so as to provide an illuminated outline at least partially around indicia defined by said first image layer.

12. A display according to claim 1, further comprising an at least partially opaque backing sheet.

13. A display according to claim 12 wherein the opaque layer is disposed on a rear face of the second transparent sheet.

14. A display according to claim 12 wherein said backing sheet has a front side that is not bonded to said rear face of said first transparent sheet.

15. A display according to claim 1 wherein said rear image layer is partially light transparent whereby, in use, light transmitted therethrough onto said backing sheet creates an illuminated aura around said rear image layer.

16. A display according to claim 1 wherein an edge of said transparent curvilinear plane which is away from said light source is adapted to reflect light incident upon said edge back into said transparent curvilinear plane.

17. A display according to claim 16 wherein said edge is inclined to a curvilinear plane defined by said transparent plane.

18. A display according to claim 17 wherein said edge is inclined at an angle of up to about 45 degrees to a line perpendicular to said curvilinear plane.

19. A display according to claim 6 further comprising a reflecting member which covers said edge thereby to reflect light into said first transparent sheet.

20. A display according to claim 12 wherein said backing sheet is parallel to said first transparent sheet.

21. A display according to claim 12 wherein there is an empty space between said front face of the backing sheet and said rear face of said first transparent sheet.

22. A display according to claim 21 wherein said backing sheet is parallel to said first transparent sheet.

23. A display according to claim 1 wherein said rear image layer is translucent and/or partially reflective.

24. A display according to claim 14, wherein said backing sheet is recessed away from said rear face such that when a portion of light is transmitted through said first transparent sheet an image of a halo or aura light is formed surrounding said rear image layer.

25. A display according to claim 1, wherein said first transparent sheet is flat.

26. The display according to claim 1 wherein said front image layer is on the front face of said first transparent sheet.

27. The display according to claim 1 further comprising a transparent cover sheet disposed outside of said first transparent sheet, said front image layer being disposed on the rear face of said transparent cover sheet.

28. The display according to claim 1 further comprising a transparent cover sheet disposed outside of said first transparent sheet, said front image layer being disposed on the front face of said transparent cover sheet.

29. The display according to claim 1 wherein the light source emits light generally in the plan of the first transparent sheet and in approximately 360 degrees.

30. The display according to claim 1, wherein the light source is positioned such that it is generally concealed from a viewer at a normal viewing position with respect to the display.

31. The display according to claim 1, wherein said from image layer comprises an at least partially reflective layer facing rearwardly towards said rear image layer.

32. The display according to claim 1, further comprising a transparent material interposed between said light source and said recess.

33. The display according to claim 32, wherein said transparent material is silicon.

34. The display according to claim 1, wherein said light source is an LED light source.

35. The display according to claim 34, wherein said recess is normal to the plane of the transparent sheet.

36. The display according to claim 35, wherein said LED light source includes a conical refractor to distribute light approximately 360 degrees and predominately into the plane of said transparent sheet.

37. The display according to claim 35, wherein said LED light source further includes a conical reflector at its distal end to distribute light approximately 360 degrees and predominately into the plane of said transparent sheet.

38. The display according to claim 34, wherein said recess is parallel to the plane of the transparent sheet.

39. A transversely-illuminated display comprising:
a first transparent sheet comprising a front face and a rear face, wherein light entering said first transparent sheet transversely will be generally transmitted edgewise through said sheet;
a light source disposed in a recess in the first transparent sheet for transmission edgewise through the first transparent sheet and positioned such that it is generally concealed from a viewer at a normal viewing position with respect to the display;
a second transparent sheet disposed in front of said first transparent sheet and generally parallel to it and not adhered or tightly in contact with portion of said first transparent sheet;
a rear image layer behind and facing said rear face of said first transparent sheet,
a front image layer, substantially in registry with said rear image layer disposed on either said first or second transparent sheet and in front of said rear image layer so that the outlines of said rear image layer are visible at normal viewing angles, said front image layer comprising an at least partially reflective surface facing toward said rear image layer;
said front image layer and said rear image layer being positioned so that light received from said light source and transmitted through said first transparent sheet will shine onto said rear image layer thereby to enhance illumination of said rear image layer.

40. The transversely illuminated display of claim 39, wherein said front image layer is disposed on a front side of said second transparent sheet.

41. The transversely illuminated display of claim 39, wherein said front image layer is disposed on a back side of said second transparent sheet.

42. The transversely illuminated display of claim 39, wherein said front image layer is disposed on a front side of said first transparent sheet.

43. The transversely illuminated display of claim 39, wherein said second transparent sheet has at least one generally opaque border and at least one light source disposed behind said opaque border.

44. The transversely illuminated display of claim 43, wherein said generally opaque border is disposed in front of said second transparent sheet.

45. The transversely illuminated display of claim 43, wherein said generally opaque border is disposed behind said second transparent sheet and in front of said first transparent sheet.

46. The transversely illuminated display of claim 1, wherein said first transparent sheet is curved.

47. The transversely illuminated display of claim 1, wherein said first transparent sheet has curved edges.

48. The transversely illuminated display of claim 43, wherein said first transparent sheet is curved.

49. The transversely illuminated display of claim 43, wherein said first transparent sheet has curved edges.

50. The transversely illuminated display of claim 29, wherein said light source includes a conical axial reflector.

51. A light source for a transversely illuminated display, comprising an LED, said LED having an axially disposed conical reflector for reflecting axial emitted light transversely to the axis of the LED.

52. The light source of claim 51, wherein said conical axial reflector is configured to reflect light approximately 360 degrees about the axis of said LED.
